(19) United States
(12) Patent Application Publication
(10) Pub. No.: US 2012/0060953 A1
(43) Pub. Date: Mar. 15, 2012

(54) AIR CONDITIONING SYSTEM SERVICE VALVE AND METHOD

(76) Inventors: Thomas C. Trent, Fort Wayne, IN (US); Roger Palmer, Cleveland Heights, OH (US); Steven H. Schnelle, Van Wert, OH (US); Vishvesh Page, Maharashtra (IN); Srinivasu Jalluri, Hyderabad Andra Pradesh (IN); Chidanand Begur, Karnataka (IN); Jayasimha Chalasani, Hyderabad Andra Pradesh (IN)

(21) Appl. No.: 13/228,770

(22) Filed: Sep. 9, 2011

Related U.S. Application Data
(60) Provisional application No. 61/381,229, filed on Sep. 9, 2010.

(51) Int. Cl. F15D 1/00; B23P 19/00

(52) U.S. Cl. 137/597; 29/428

(57) ABSTRACT

An air conditioning service valve includes a valve body with a pair of tubes extending from the valve body. The tubes have respective first ends, proximal to the valve body, that extend away from the valve body at nonzero angles to one another, such as substantially perpendicular. One of the tubes has a bend, such that second ends of the tubes, distal to the valve body, are substantially parallel to one another. The air conditioning service valve may be mounted to a bracket without use of fasteners, for example with the valve body engaging edges, tangs, and/or tabs of the bracket. The valve body also has a stem port and a charge port, with the stem port parallel to the second ends of the tubes. The arrangement of the tubes allows use of a smaller valve body, while also reducing pressure drop relative to prior Z-flow valves.

This application claims the benefit of U.S. Provisional Application 61/381,229, filed Sep. 9, 2010, which is incorporated by reference in its entirety.

### FIELD OF THE INVENTION

The present invention relates to an air conditioning service valve, to methods of mounting the valve.

### DESCRIPTION OF THE RELATED ART

Frontseat service valves are designed to be used in residential air conditioning and heating systems such as split air conditioning equipment and heat pumps. Frontseat service valves are used to isolate sections of an air conditioning system during diagnostic servicing, installation, repair, and to permit technicians to provide refrigerant charging and evacuating capabilities. Frontseat service valves contain one sealing surface on the front side of the valve stem. Every split air conditioning and heat pump unit makes use of two frontseat service valves. One frontseat service valve is a larger diameter valve used for outgoing refrigerant gas and the other is a smaller diameter suction valve used for incoming compressed liquid. Frontseat service valves typically range in size from ⅜-inch to 1⅛-inch in diameter. Frontseat service valves perform essentially three primary functions in split air conditioning units and heat pumps: 1) contain the refrigerant in the condensing unit prior to the installation; 2) provide shut-off capability that enables the unit to be serviced once installed; and 3) provide a service port by which a hose connection can be used to evacuate the refrigerant medium or monitor the system pressure for diagnostic purposes.

Prior art for frontseating style valves for residential air conditioning and heat pump systems (part of condensing unit assemblies) consist generally of Z-flow valves and L-flow valves.

A Z-flow valve typically has the field and factory copper connection tubes that are parallel to each other and protruding from a single body. The field tube and the factory tube are offset from each other so that a seal can be made between them. The Z-flow valve is the most common valve due to the ease in mounting the parallel tubes into the system. However, the Z-flow valve exhibits poor flow characteristics in that the fluid must take two sharp ninety degree turns through the valve resulting in a high pressure drop. The body of the Z-valve also must be large in order to accommodate the offset of the field tube and the factory tube.

An L-flow valve has the field and factory copper connection tubes that are perpendicular to each other protruding at ninety degree angles from each other from a single body. The L-flow valve exhibits better flow characteristics than the Z-flow valve in that the fluid must only take one sharp ninety degree turn through the valve resulting in a lower pressure drop. The body of the L-valve can also be smaller than the body of the Z-valve as there is no offset of the field tube and the factory tube to accommodate. However, the L-flow valve is difficult to mount in the system as the tubes are at ninety degree angles from each other.

The current state of art for mounting frontseat valves into condensing units is by driving screws through holes in the unit base pan and into holes bored into the valve body. This mounting concept is wasteful in that it requires extra screws and the brass necessary to provide mounting holes.

In view of the foregoing, various improvements in air conditioning service valves, and mountings for such valves, would be desirable.

### SUMMARY OF THE INVENTION

According to an aspect of the invention, an air conditioning service plug-type valve includes: a valve body having a stem port leading to an internal chamber; a charge port extending from the body; a first port tube extending from the body and having a first end attached to the valve body and a second end distal from the valve body; a second port tube extending from the body and having a first end attached to the valve body and a second end distal from the valve body, the second port tube formed at least in part as a ninety degree radius along an axial length thereof; a charge port extending from the body; the first end of the first port tube is attached to the valve body at a position generally perpendicular to the first end of the second port tube; the second end of the first port tube is generally parallel to the second port tube. According to another aspect of the invention, the first port, the charge port, and the second port are formed in the same plane.

According to another aspect of the invention, an air conditioning system service valve includes: a valve body having a stem port leading to an internal chamber; a charge port extending from the valve body; a first port tube extending from the valve body and having a first end attached to the valve body and a second end distal from the valve body; and a second port tube extending from the body and having a first end attached to the valve body and a second end distal from the valve body. The first end of the second port tube is attached to the valve body at a position generally perpendicular to the first end of the first port tube. The second end of the second port tube is generally parallel to the first port tube.

According to yet another aspect of the invention, an air conditioning service valve installation includes: an air conditioning system service valve; and a bracket to which the air conditioning service valve is coupled. The air conditioning system service valve includes: a valve body having a stem port leading to an internal chamber; a charge port extending from the valve body; a first port tube attached to and extending from the valve body; and a second port tube attached to and extending from the valve body. The valve is fastenerlessly-coupled to the bracket.

According to still another aspect of the invention, a method of coupling an air conditioning system service valve to a bracket includes: placing a valve body of the valve into the hole in the bracket; and fasternessly securing the valve body to the bracket. The valve includes: a stem port in the valve body that leads to an internal chamber; a first port tube attached to and extending from the valve body; and a second port tube attached to and extending from the valve body. The first port tube is substantially in line with the stem port. The second port tube and the stem port are on the same side of the bracket.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The appended drawings show various features of embodiments of the invention.

FIG. 1 is an oblique view of an air conditioning service valve in accordance with an embodiment of the present invention.

FIG. 2 is a side, partial-cutaway view of the valve of FIG. 1.

FIG. 3 is an oblique view of the valve of FIG. 1 shown mounted in a base pan flange with a slot for the bent tube.

FIG. 4 is an oblique view of the base pan flange of FIG. 3.

FIG. 5 is an oblique view of a bracket usable for mounting the valve of FIG. 1

FIG. 6 is an end view of the bracket of FIG. 5.

FIG. 7 is a plan view of the bracket of FIG. 5, showing the positions of valves mounted in the bracket.

FIG. 8 is a side view of the bracket-and-valve combination of FIG. 7.

FIG. 9 is a plan view of the bracket-and valve combination, showing barbs of the bracket.

FIG. 10 is a plan view showing the configuration of part of the bracket of FIG. 5 prior to installation of a valve.

FIG. 11 is an oblique view of an alternate embodiment bracket usable for mounting the valve of FIG. 1.

FIG. 12 is a side view of a bracket-and-valve combination in accordance with yet another alternate embodiment of the invention.

FIG. 13 is a side view of a bracket-and-valve combination in accordance with still another alternate embodiment of the invention.

FIG. 14 is an oblique view of a bracket-and-valve combination in accordance with a further alternate embodiment of the invention.

FIG. 15 is another oblique view of the combination of FIG. 14.

FIG. 16 is an oblique view of another embodiment of air conditioning service valve in accordance with the invention.

FIG. 17 is an oblique view of the valve of FIG. 16 mounted to a base pan or bracket.

FIG. 18A is graph showing a pressure drop comparison of a valve size of the current invention valve embodiment and a corresponding-sized valve of a Z-flow configuration.

FIG. 18B is graph showing a pressure drop comparison of another valve size of the current invention valve embodiment and another corresponding-sized valve of a Z-flow configuration.

FIG. 19 is a graph showing a pressure drop comparison of a ⅞ inch Z-flow valve and a ⅞ inch valve of the current invention having a smaller valve body.

### DETAILED DESCRIPTION

An air conditioning service valve includes a valve body with a pair of tubes extending from the valve body. The tubes have respective first ends, proximal to the valve body, that extend away from the valve body at nonzero angles to one another, such as substantially perpendicular. One of the tubes has a bend, such that second ends of the tubes, distal to the valve body, are substantially parallel to one another. The air conditioning service valve may be mounted to a bracket without use of fasteners, for example with the valve body engaging edges, tangs, and/or tabs of the bracket. The valve body also has a stem port and a charge port, with the stem port parallel to the second ends of the tubes. The arrangement of the tubes allows use of a smaller valve body, while also reducing pressure drop relative to prior Z-flow valves.

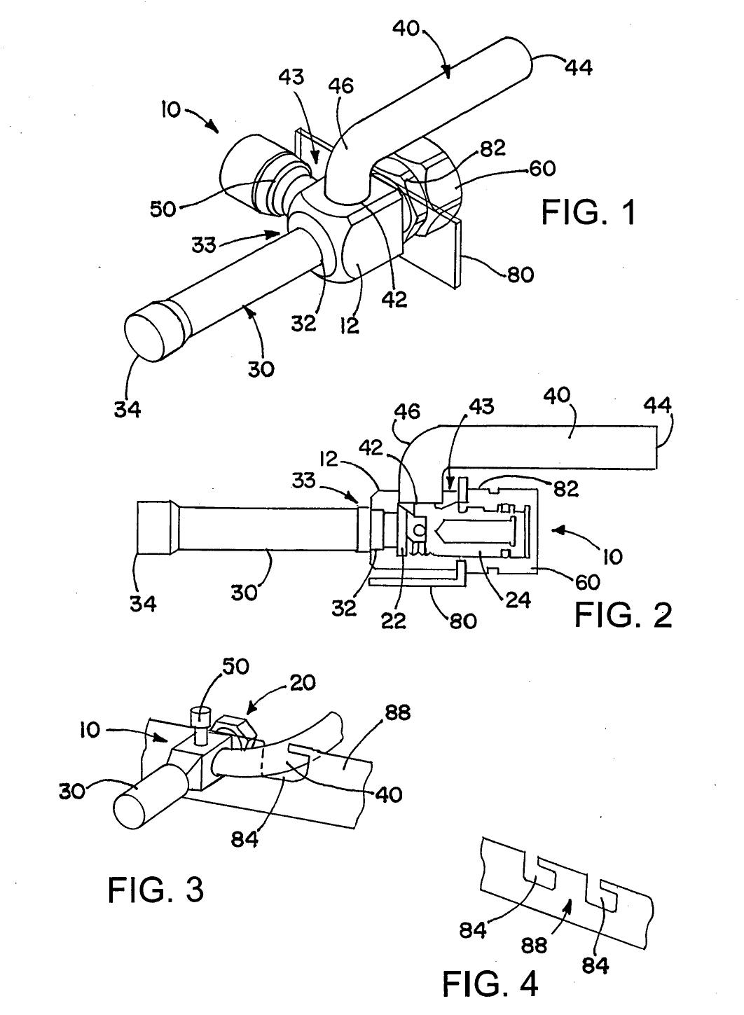

Referring to FIGS. 1 and 2, a valve 10 is shown having a valve body 12, the valve body 12 having a stem port 20 leading to an internal chamber 22 for a plug 24. The plug 24 engages threads on the inside of the stem port 20. The plug 24 can be threaded in and out to control flow into and through the valve body 12. The valve body 12 may be made of brass or another suitable material, for example copper. The body 12 and associated components of the valve 10 are not limited to a particular material. For example, the body 12 could also be made of stainless steel, aluminum, or any other suitable material.

A first port tube or factory port tube 30 has a first end 32 attached to a first port 33 of the valve body 12, and a second end 34 distal from the valve body 12. A second port tube or field port 40 has a first end 42 attached to a second port 43 of the valve body 12, and a second end 44 distal from the valve body 12. The stem port 20, the first port tube 30, the first port 33, the second port tube 40, and the second port 43 all may be substantially co-planar. The tubes 30 and 40 may be copper tubes, or may be made from another suitable material, such as those listed above. The proximal ends 32 and 42 of the tubes 30 and 40 may be permanently attached to the valve body 12 by a suitable attachment process, such as brazing.

The second port tube 40 is formed at least in part as a ninety degree radius 46 along an axial length of the second port tube 40, between the first (proximal) end 42 and the second (distal) end 44. The bend 46 may have a bend radius that is from 0.75 to 2 times the diameter of the second port tube 40. More narrowly the bend radius of the bend 46 may be from 1 to 2 times the diameter of the second port tube 40, or may be approximately equal to the diameter of the second port tube 40. The inlet end (first end) 32 of the first port tube 30 is attached to the valve body 12 at a position generally perpendicular to the inlet end (first end) 42 of the second port tube 40. The outlet end (second, distal) 44 of the second port tube 40 is generally parallel to the first port tube 30.

In the illustrated embodiment the valve body 12 has a rectangular cross section, such as a substantially square cross section. As an alternative the valve body 12 may have a different cross-sectional shape, such as a round cross section.

A charge port 50 is also shown extending from the valve body 12. A cap 60 is used to cover the stem port 20, to limit access to the plug 24. The cap 60 is threaded onto external threads of the stem port 20.

By placing the tubes 30, 40 in positions perpendicular to each other on the valve body 12, the valve body 12 can be significantly shorter than bodies of corresponding Z-flow valves. This results in material and weight savings. The material and weight savings may be about 25% of the material/weight of a valve body of a prior Z-flow valve.

In FIGS. 1 and 2, the valve 10 is shown mounted to a bracket 80 wherein the bracket has an aperture through which the body 12 is positioned and secured thereto by a stop nut 82. The stop nut 82 in the illustrated embodiment is shown as being part of the stem port cap 60, although the stop nut 82 alternatively may be a separate part. As the valve 10 is typically mounted to the condenser unit base pan, access to the charging port 50 can be problematic if not mounted in a particular orientation.

Referring to FIGS. 3 and 4, a bracket 88 is shown having two apertures 84 such that the valve 10 is held with the charging port 50 in an accessible position. The field port tube 40 can be snapped into place with a tabbed aperture 84. Advantageously the field port tube 40 and the stem port 20 are accessible from the same side of the bracket 88.

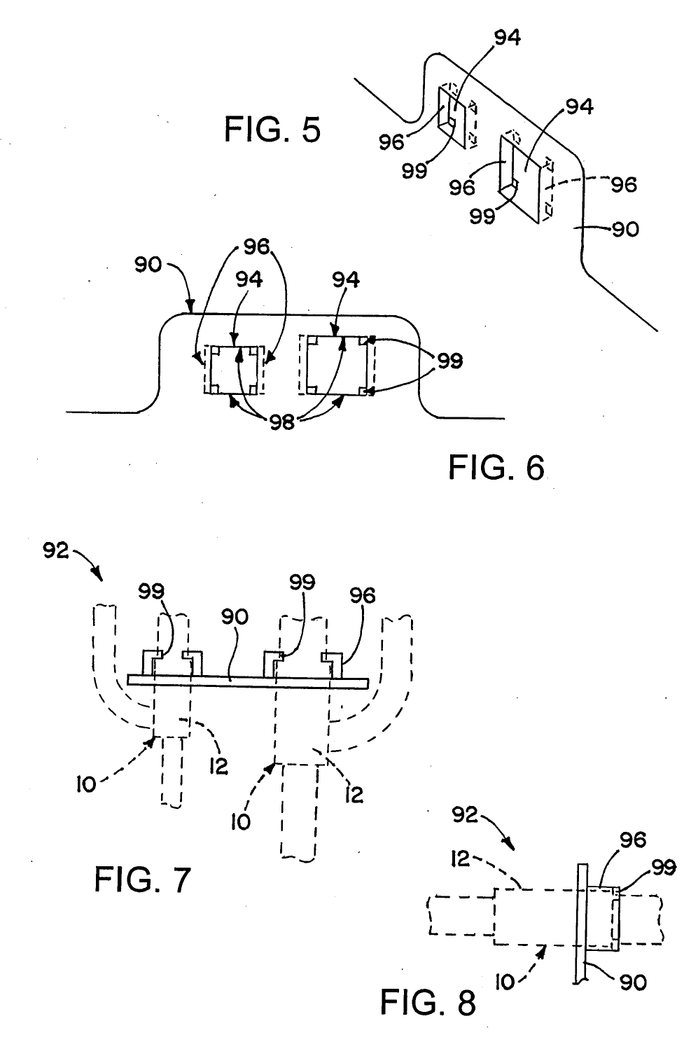

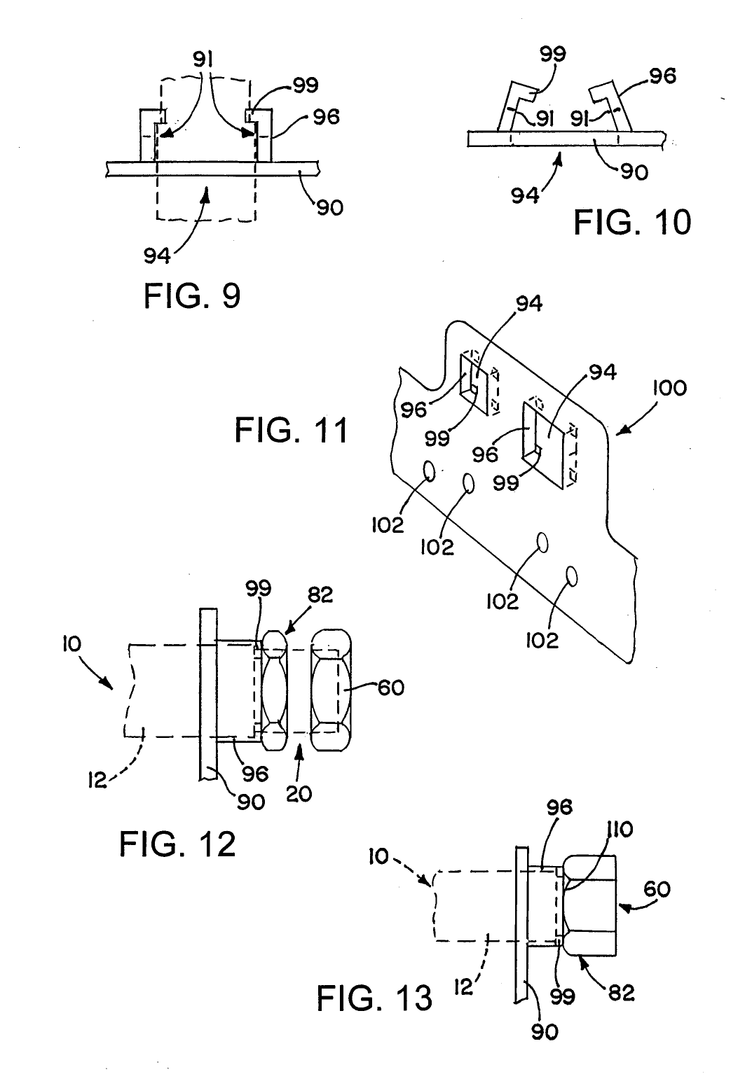

FIGS. 5-10 refer to the mounting of the valve 10 to the condenser unit base pan or bracket 90 that is a fastenerless coupling, without use of screws or other fasteners. The combination of the valve 10 and the bracket 90 produces an air conditioning service valve installation 92. The improved mounting configuration is illustrated will work with square body valve. The mounting method entails creating square pockets or holes 94 in the base pan (bracket) 90 with uniquely shaped and folded edges 96 along the sides, and with straight sheared edges 98 along the top and bottom of the pockets or holes 94. These folded edges 96 can be folded at angles less than 90 degrees so they create a spring effect upon insertion of the valve body into the pocket as best shown in FIG. 10. At the top and bottom of each end of the folded edges 96 are inwardly-folded tangs 99 to serve as stops for the valve body 12. Also, barbs 91 are stamped into the folded edges 96 at intermediate depths to prevent the valve body 12 from coming back out of the base pan without the use of screws. The sheared edges 98 provide sharp edges that engage the outer surface of the valve body 12, and help keep the valve 10 inserted in the bracket 90, once the valve 10 is installed.

In FIG. 11, a mountable bracket 100 is shown that can be bolted to the base pan with the same screws used to mount conventional service valves. The bracket 100 has screw holes 102 for receiving screws for mounting to the base pan. The engagement of the valve 10 (FIG. 1) to the bracket 100 is the same as for the bracket 90 (FIGS. 5-10), utilizing folded edges 96 with stop tangs 99 to secure a valve bodies in holes or pockets 94.

FIG. 12 shows another way of mounting the valve 10 to the bracket 90. A stop nut 82, separate from the stem port cap 60, is threaded onto external threads of the stem port 20. This clamps the stop tangs 99 between the stop nut 82 and the valve body 12.

FIG. 13 shows a further variant, with the stop tangs 99 clamped between the valve body 12 and a stem port cap 60 that includes the stop nut 82. A compressible gasket 110 may be placed between the stop nut 82 and the stop tangs 99.

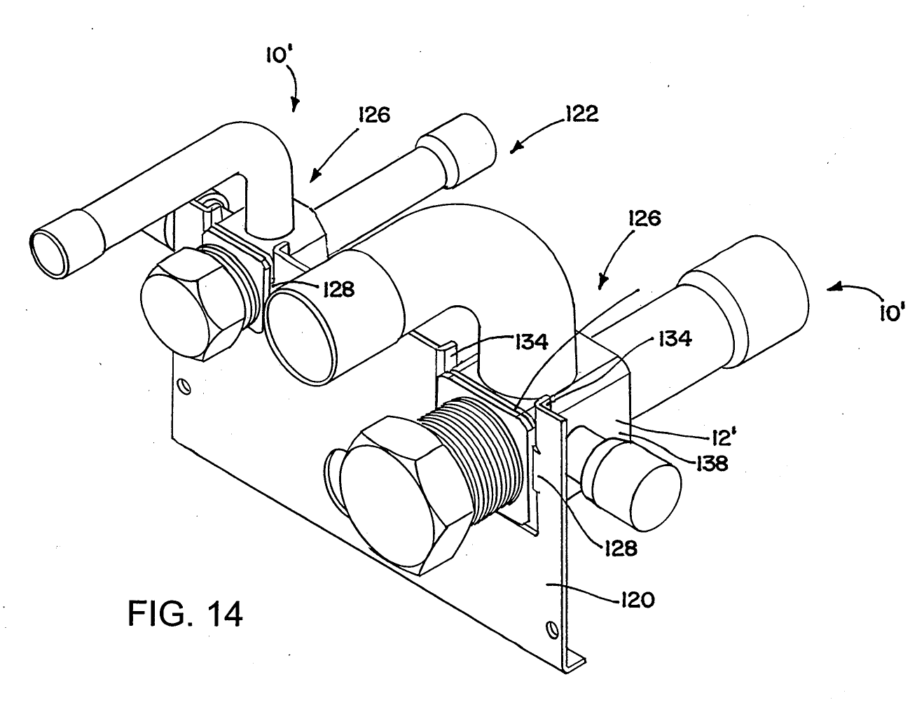

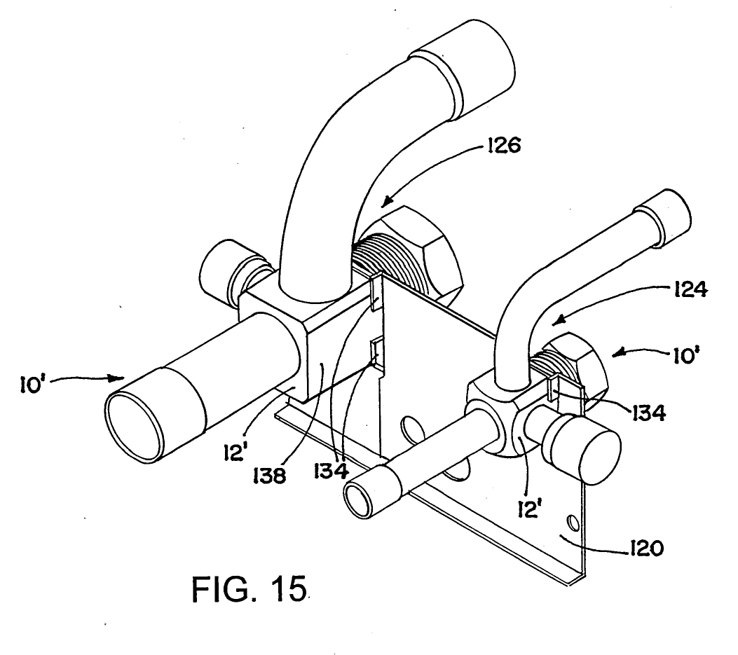

FIGS. 14 and 15 show an alternative mounting a bracket 120 that includes for its holes 122 a pair of slots 124 and 126 for receiving valves 10′ of various sizes. The slots 124 and 126 each have tabs 128 on their left and right edges. The tabs 128 engage a groove 130 on the valve body 12′, to keep the valve body 12′ in the slots 124 and 126. Folded right-angle flanges 134 are above and below the tabs 128. The folded flanges 134 press against major surfaces 138 of the valve body 12′, to help keep the valve body 12′ in place and properly aligned relative to the slots 124 and 126.

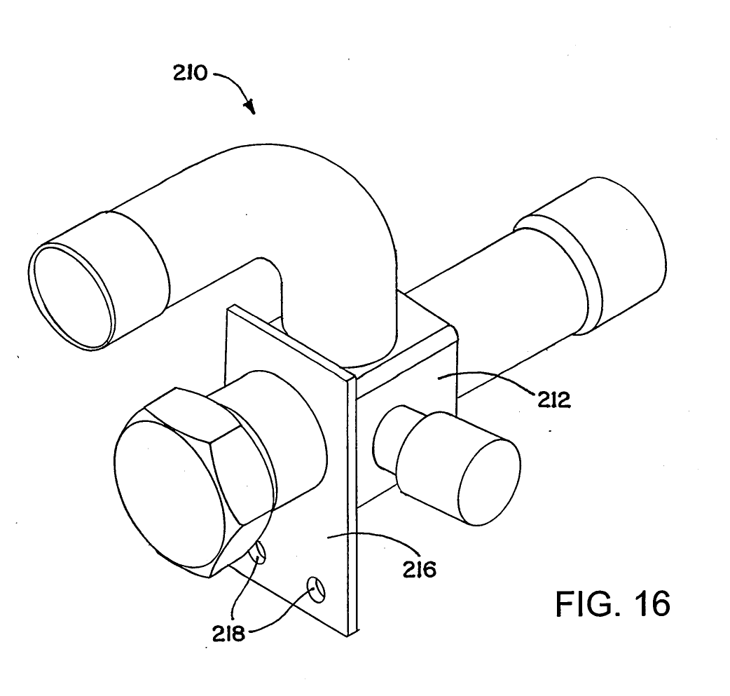

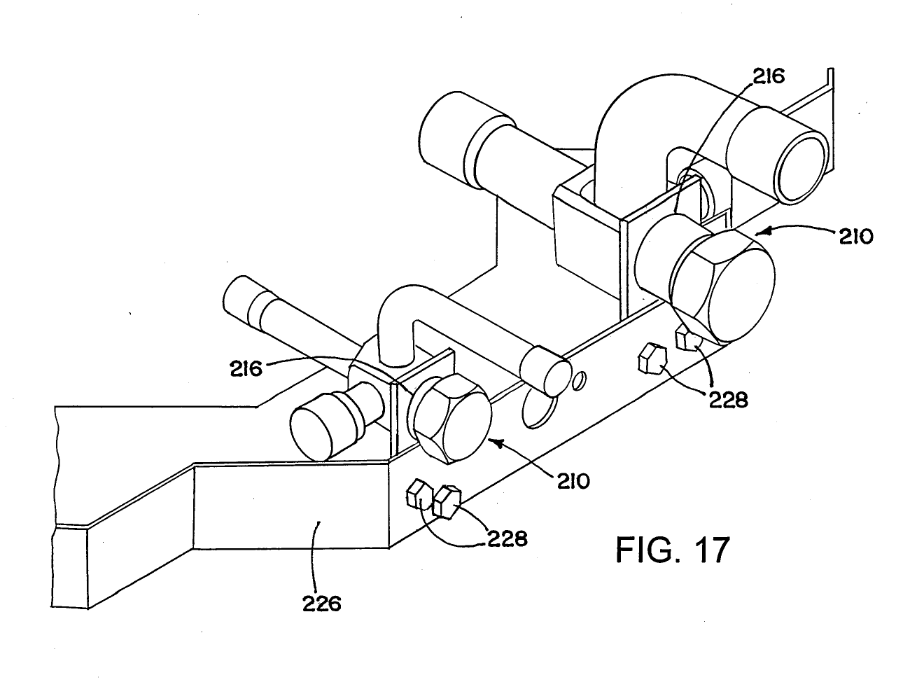

FIG. 16 shows another alternative, a valve 210 that has a valve body 212 with an integral plate 216 that has holes 218. The plate 216 may be mounted to a base pan 226, as shown in FIG. 17, using appropriate screws or other threaded fasteners 228. In other respects the valve 210 may be similar to the other valves disclosed herein.

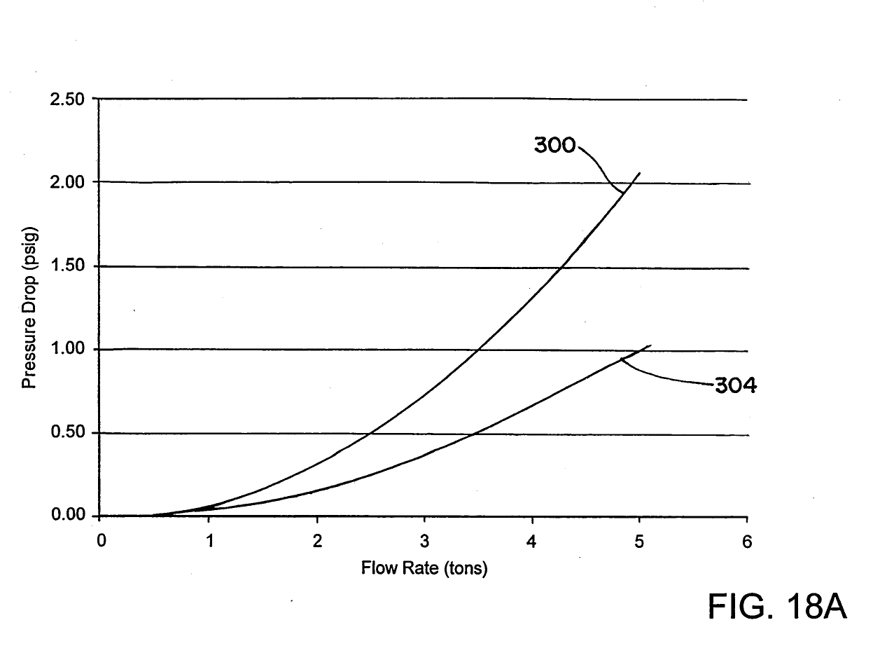

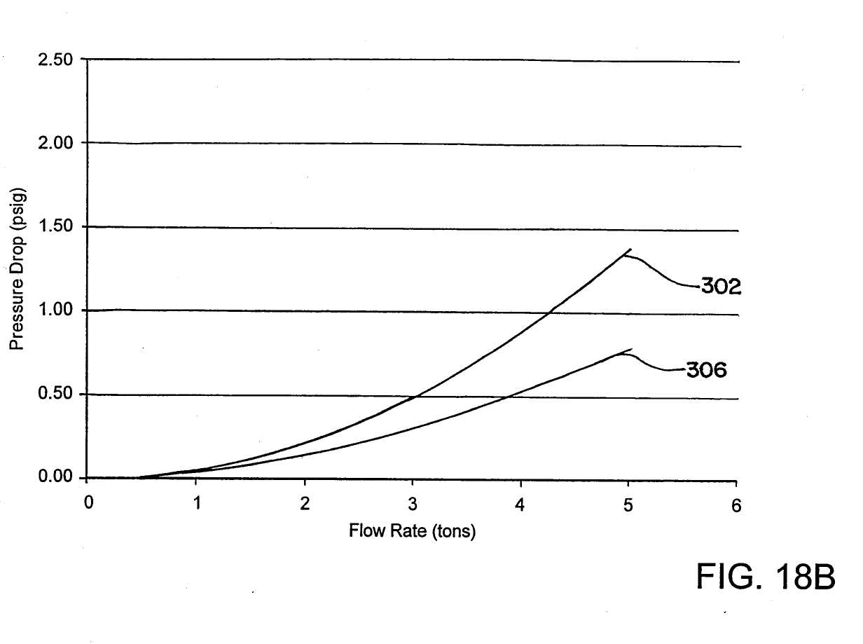

FIGS. 18A and 18B show that the valve 10 provides a significantly lower pressure drop as compared to the Z-flow valve. In the graphs, the current −12 (¾-inch) and −06 (⅜-inch) valves (reference numbers 300 (FIG. 18A) and 302 (FIG. 18B), respectively) had about twice the pressure drop of the −12 (¾-inch) and −06 (⅜-inch) valves of the current invention (reference numbers 304 (FIG. 18A) and 306 (FIG. 18B), respectively). The gradual bend 46 of the second port tube 40 (FIG. 1) produces less of a pressure drop than a sharp turning of the flow within a valve body, as is done twice in prior Z-valves.

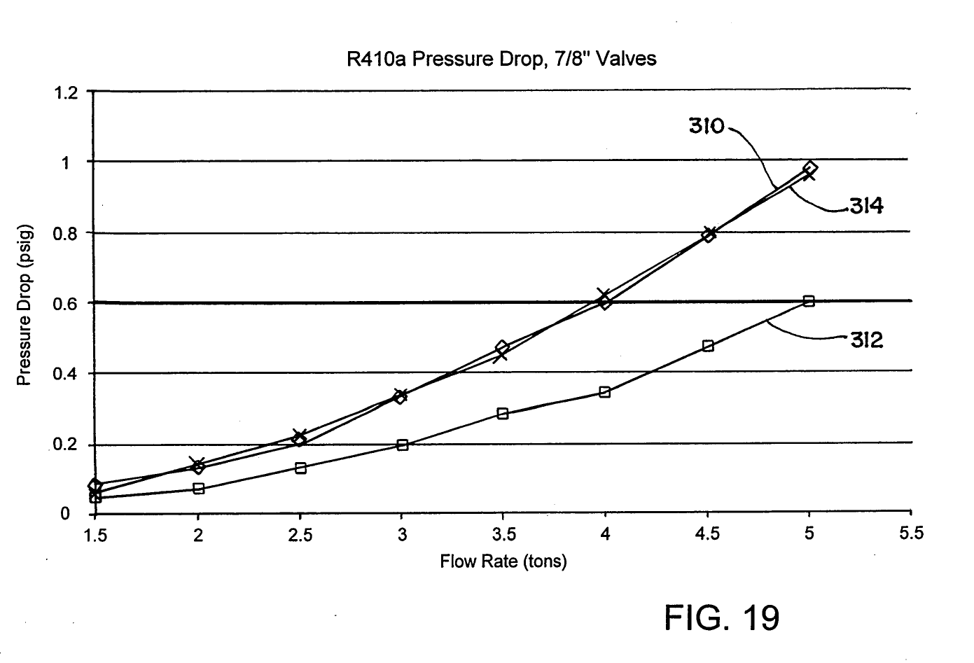

FIG. 19 shows a comparison of the pressure drop for a standard Z-flow—14 valve (reference number 310) against a −14 (⅞-inch) valve 10 of the current invention (reference number 312), and against a −14 (⅞-inch) valve 10 having a down-sized valve body from that of a −14 (⅞-inch) valve to that of a −12 (¾-inch) valve (reference number 314). The valve of the current invention having a down- sized body reduced the weight of the −14 (⅞-inch) valve by 37.5% without diminishing performance with regard to the pressure drop across the valve. The −14 (⅞-inch) valve of the current invention performed significantly better that the standard Z-flow −14 (7/8-inch) valve.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An air conditioning system service valve comprising:
a valve body having a stem port leading to an internal chamber;
a charge port extending from the valve body;
a first port tube extending from the valve body and having a first end attached to the valve body and a second end distal from the valve body; and
a second port tube extending from the body and having a first end attached to the valve body and a second end distal from the valve body;
wherein the first end of the second port tube is attached to the valve body at a position generally perpendicular to the first end of the first port tube; and
wherein the second end of the second port tube is generally parallel to the first port tube.

2. The air conditioning system service valve of claim 1, wherein the port tubes are brazed to the valve body.

3. The air conditioning system service valve of claim 1,
wherein the first port tube extends from a first port of the valve body;
wherein the second port tube extends from a second port of the valve body; and
wherein the first port, the charge port, and the second port are substantially co-planar.

4. The air conditioning system service valve of claim 1, wherein the second port tube has a bend of at least 90 degrees between the first end of the second port tube and the second end of the second port tube.

5. The air conditioning system service valve of claim 4, wherein the bend has a bend radius that is from 0.75 to 2 times a diameter of the second port tube.

6. The air conditioning system service valve of claim 1, wherein the stem port is substantially parallel to the second end of the second port tube.

7. The air conditioning system service valve of claim 1, wherein the valve body has a square cross section.

8. The air conditioning system service valve of claim 1, further comprising a plug that is threaded into the stem port.

9. The air conditioning system service valve of claim 8, further comprising a valve cap that is removably threaded onto an external surface of the stem port, to control access to the plug.

10. The air conditioning system service valve of claim 1, in combination with a bracket to which the air conditioning service valve is coupled.

11. The combination of claim 10, wherein the valve is fastenerlessly-coupled to the bracket.

12. The combination of claim 10, wherein the valve body is secured in a hole in the bracket.

13. The combination of claim 12, wherein the hole has sheared edges that engage an outer surface of the valve body.

14. The combination of claim 12, wherein the bracket has stop tangs that engage the valve body to limit insertion of the valve body into the hole.

15. The combination of claim 14, wherein the stop tangs are on folded edges of the bracket that are on opposite sides of the hole.

16. The combination of claim 15, wherein the folded edges are folded at angles of less than 90 degrees relative to the rest of the bracket, angling toward the hole prior to insertion of the valve body into the hole.

17. The combination of claim 15,
wherein the folded edges have barbs on respective inner surfaces; and
wherein the barbs engage the outer surface of the valve body, when the valve body is inserted in the hole.

18. The combination of claim 14, further comprising a stop nut, threaded onto an external surface of the stem port, with the stop tangs secured between the valve body and the stop nut.

19. The combination of claim 12, wherein the hole is a tabbed aperture that has a tab that engages the valve body.

20. The combination of claim 12, wherein the hole tabbed aperture includes tabs on opposite edges that engage a slot in the valve body.

21. The combination of claim 20, wherein the bracket further include respective folded flanges adjoining the tabs, having major surfaces that press against major surfaces of the valve body.

22. The combination of claim 10, wherein the valve body includes a plate that is coupled to the bracket with threaded fasteners.

23. An air conditioning service valve installation comprising:
an air conditioning system service valve; and
a bracket to which the air conditioning service valve is coupled;
wherein the air conditioning system service valve includes:
a valve body having a stem port leading to an internal chamber;
a charge port extending from the valve body;
a first port tube attached to and extending from the valve body; and
a second port tube attached to and extending from the valve body; and
wherein the valve is fastenerlessly-coupled to the bracket.

24. The air conditioning service valve installation of claim 23, wherein the valve body is secured in a hole in the bracket;
wherein the first port tube has a first end attached to the valve body and a second end distal from the valve body;
wherein the second port tube has a first end attached to the valve body and a second end distal from the valve body;
wherein the first end of the second port tube is attached to the valve body at a position generally perpendicular to the first end of the first port tube; and
wherein the second end of the second port tube is generally parallel to the first port tube.

25. A method of coupling an air conditioning system service valve to a bracket, the method comprising:
placing a valve body of the valve into the hole in the bracket; and
fasternessly securing the valve body to the bracket;
wherein the valve includes:
a stem port in the valve body that leads to an internal chamber;
a first port tube attached to and extending from the valve body; and
a second port tube attached to and extending from the valve body;
wherein the first port tube is substantially in line with the stem port; and
wherein the second port tube and the stem port are on the same side of the bracket.
